(19) United States
(12) Patent Application Publication
(10) Pub. No.: US 2023/0073226 A1
(43) Pub. Date: Mar. 9, 2023

(54) SYSTEM AND METHOD FOR BOUNDING MEANS OF DISCRETE-VALUED DISTRIBUTIONS

(71) Applicant: YAHOO ASSETS LLC, DULLES, VA (US)

(72) Inventor: Eric Bax, Sierra Madre, CA (US)

(21) Appl. No.: 17/470,677

(22) Filed: Sep. 9, 2021

(51) Int. Cl. G06F 16/28; G06F 17/16

(52) U.S. Cl. CPC G06F 16/285; G06F 17/16; G06Q 30/0201

(57) ABSTRACT

The present teaching relates to method, system, medium, and implementations for characterizing data with categorical classes and the number of observations for each of the categorical classes. Each categorical class is associated with a category value. The categorical classes are arranged in a first order based on category values. A total of observations is determined based on the numbers of observations for each categorical class. A bound of the average value of the data is estimated based on the categorical classes, the total of observations, and the numbers of observations for the categorical classes in accordance with a dot product of a probability vector and a categorical class vector comprising the category values of the categorical classes.

### BACKGROUND

### 1 Technical Field

The present teaching generally relates to computing. More specifically, the present teaching relates to characterizing data via big data processing.

### 2. Technical Background

With the development of the Internet and the ubiquitous network connections, more and more commercial and social activities are conducted online. To facilitate a more productive online environment, information about different online events is collected and analyzed in order to more effectively utilize the online environment. For example, data on subscribers for a new service may include which tier of service each subscriber selected, and subscription pricing may be based on tier of service. This is shown in FIG. 1A. A new service may be offered with multiple tiers/categories of services (100) and each tier/category i is associated with a value or price Pi, i.e., the price for tier 1 service is P1 (100-1), the price for tier 2 service is P2 (100-2), . . . , the price for tier V service is Pv (100-3). For each category of services, the number of users who signed up on that tier of service is recorded, e.g., K1 users signed up for tier 1 service (110-1), K2 users signed up for tier 2 service (110-2), . . . , Kv−1 users signed up for tier v−1 service (110-3), and Kv users signed up for tier v service (110-4). With such collected data, an average revenue per additional subscriber (120) may be computed and can be used to best facilitate the online operations.

Another example is about average value per click on an advertisement. This is shown in FIG. 1B. An advertisement may be displayed to users in different settings/scenarios (130), which can be different settings (Yahoo!, Google, Facebook, etc.) in which the advertisement is presented to users. In each scenario, the number of clicks on the advertisement displayed therein may be recorded. A value may be assigned to a display of the advertisement in each scenario, e.g., value V1 130-1 is associated with a display of the advertisement in scenario 1, value V2 130-2 is associated with a display of the advertisement in scenario 2, . . . , value Vk 130-3 is associated with a display of the advertisement in scenario k. For each scenario, the number of clicks 140 is collected, i.e., the number of clicks K1 (140-1) on the advertisement displayed in scenario 1, the number of clicks K2 (140-2) on the advertisement displayed in scenario 2, . . . , the number of clicks Kv (140-4) on the advertisement displayed in scenario K. From such collected data, the statistic of an average value per click on the advertisement may be determined. Such statistic such as an average may be used to, e.g., maximize the financial gain via online operation.

A statistic computed based on a collection of data is usually a single number as shown in FIG. 2. A common statistic is a mean or average, which may characterize in some way a distribution. In some applications, it may be desirable to bound such a statistic such as a mean to a range. One example is provided in FIG. 2 where a statistic (such as an average) 200 may have an mean or average 210 which, although a single statistic value, is bounded by a range characterized by, e.g., a lower bound value 220 and an upper bound value 230.

Existing approaches to obtaining bounds on population or distribution averages treat each of the sample values as a sequence of values and use distribution-free concentration inequalities that relate distribution means to empirical means or those that also use information about the empirical variance. No extra information about an underlying distribution associated with some known characteristics of the data is utilized to improve the estimation of the bounds of statistics, such as a mean of a distribution.

Thus, there is a need for a solution that address the shortcomings of and enhance the performance of the traditional approaches.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for characterizing data with categorical classes and the number of observations for each of the categorical classes. Each categorical class is associated with a category value. The categorical classes are arranged in a first order based on category values. A total of observations is determined based on the numbers of observations for each categorical class. A bound of the average value of the data is estimated based on the categorical classes, the total of observations, and the numbers of observations for the categorical classes in accordance with a dot product of a probability vector and a categorical class vector comprising the category values of the categorical classes.

In a different example, a system is disclosed for characterizing data. The system includes a data categorization unit, a category observation extractor, a category total determination unit, and a bound estimation mechanism. The data categorization unit is configured for receiving data including categorical classes, wherein each of the categorical classes is associated with a category value and the categorical classes are arranged in a first order based on their corresponding category values. The category observation extractor is configured for identifying the number of observations from the data with respect to each of the categorical classes. The category total determination unit is configured for determining a total of observations based on the numbers of observations with respect to the respective categorical classes. The bound estimation mechanism is configured for estimating a bound of an average value of the data based on the categorical classes, the total of observations, and the numbers of observations with respect to the categorical classes in accordance with a dot product of a probability vector and a categorical class vector comprising the category values of the categorical classes.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for characterizing data. The information, when read by the machine, causes the machine to perform various steps. Data are received with categorical classes and the number of observations for each of the categorical classes. Each categorical class is associated with a category value. The categorical classes are arranged in a first order based on category values. A total of observations is determined based on the numbers of observations for each categorical class. A bound of the average value of the data is estimated based on the categorical classes, the total of observations, and the numbers of observations for the categorical classes in accordance with a dot product of a probability vector and a categorical class vector comprising the category values of the categorical classes.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1A-1B provide examples of collected data and statistics computed therefrom;

FIG. 2 illustrates an exemplary statistic and a range specified by bounds of the statistic;

FIG. 3 depicts an exemplary high-level system diagram of a mechanism for determining bounds of a mean based on data, in accordance with an exemplary embodiment of the present teaching;

FIG. 4 is a flowchart of an exemplary process for a mechanism for determining bounds of a mean based on data, in accordance with an exemplary embodiment of the present teaching;

FIG. 5A depicts an exemplary high-level system diagram of an upper bound estimation unit, in accordance with an exemplary embodiment of the present teaching;

FIG. 5B is a flowchart of an exemplary process of an upper bound estimation unit, in accordance with an exemplary embodiment of the present teaching;

FIG. 6A depicts an exemplary high-level system diagram of a lower bound estimation unit, in accordance with an exemplary embodiment of the present teaching;

FIG. 6B is a flowchart of an exemplary process of a lower bound estimation unit, in accordance with an exemplary embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching aims to address the deficiencies of the current state of art in determining bounds of means of a discrete-valued distribution. When per-category values are known, additional information about the distribution may be explored. For example, if a distribution is known to have a discrete set of values in pre-determined values, such information may be explored to produce stronger bounds. The present teaching describes an approach that is validation by inference by using a set of distributions that includes all those for which the data samples are likely (in the sense of not being too far out in the tails of the distributions) and then identifying distributions in the likely set that have minimum or maximum means. The minimum and maximum are lower and upper bounds, respectively, on the mean of the distribution that generated our samples, with probability of bound failure no more than the probability that the samples are too far out in the tail of their distribution.

In big-data settings, the data are often samples from a population, and we want to use the data to infer information about the population. So, we use sample statistics to estimate or bound population statistics. In the embodiments presented herein, population averages of values that are determined by categories are bounded based on samples with known categories. The samples are assumed to be drawn from independent and identically distributed (i.i.d.) population with replacement, or, equivalently, i.i.d. from an unknown generating distribution, with the goal of bounding the average value over the generating distribution.

Background information is provided first. Assume that there are m categories, k=(k₁, . . . , kₘ) be the numbers of samples for each of the m categories and n=k₁+ . . . +kₘ be the total number of samples. Assume the samples were drawn i.i.d. from an unknown multinomial distribution denoted as p*=(p₁*, . . . , pₘ*). Let v=(v₁, . . . , vₘ) be category values with v₁< . . . <vₘ. The goal is to compute probably approximately correct (PAC) bounds on p*·v. The expectation of category value over distribution p*, with some specified probability of bound failure at most δ>0.

When there are two categories, i.e., m=2, then p* is a binomial distribution so that a bound can be computed using binomial inversion, as illustrated below. Define B(n, k, p) to be the left tail (the cumulative distribution function or c.d.f) of the binomial distribution:

$$B ( n , k , p ) = {\sum }_{i = 0}^{k} ( \begin{matrix}n \\ i\end{matrix} ) {{p}^{i} ( 1 - p )}^{n - i} , \qquad ( 1 )$$

Then, with probability at least 1−δ, the binomial inversion upper bound:

p₊(n,k,δ)=max{p:B(n,k,p)≥δ}. (2)

is at least the probability of an event that occurs k times in n Bernoulli trials. This bound is sharp in the sense that the bound failure probability is δ. It can be readily computed because B(n, k, p)≥δ for all p≤p₊(n, k, p) and B (n, k, p)<δ for all p>p₊(n, k, p). Given that, a binary search can be performed over p∈[0, 1], with precision 1/2^{s}, after s search steps. Thus, for m=2, with probability at least 1−δ,

p₂*≤p₊(n,k₂,δ), (3)

and so

p*·v≤[1−p₊(n,k₂,δ)]v₁+p₊(n,k₂,δ)v₂ (4)

as increasing p₂* increases p*·v. (because v₁<v₂). For a lower bound on p*·v, with probability at least 1−δ,

p₁*≤p₊(n,k₁,δ). (5)

Thus,

p*·v≥p₊(n,k₁,δ)v₁+[1−p₊(n,k₁,δ)]v₂. (6)

To compute the lower bound, p₋(n, k, δ), the computation procedure is the same except the order of elements in k and v are now reversed, i.e., the values are in a descending order. To compute two-sided (simultaneous upper and lower) bounds,

$$\frac{δ}{2}$$

is used in place or δ in determining each bound with Bonferroni correction or the union bound because the probability of the union of events is at most the sum of the probabilities of events.

The probability of a sample being in a single category rather than any of the others has a binomial distribution. So, we can use binomial inversion to bound the probability of membership in each category. In this section, we combine binomial inversions for each category using a Bonferroni correction, forming a likely set that is a rectangular prism (a “box”) that contains the generating distribution with probability at least 1−δ. Given such a simple shape for the likely set, it is easy to find the distribution in the set that maximizes p·v to produce an upper bound on the expectation of category values.

Define a binomial inversion lower bound as:

p₋(n,k,δ)=min{p:1−B(n,k−1,p)≥δ}. (7)

and use it to define a Bonferroni box:

$${L}_{B} = {x}_{i ∈ M} [ {p}_{-} ( n , {k}_{i} , \frac{δ}{2 * m} ) , {p}_{+} ( n , {k}_{i} , \frac{δ}{2 * m} ) ] , \qquad ( 8 )$$

where M={1, . . . , m}. With probability at least 1−δ,

p*∈L_{B},

since

$${∀}_{i} ∈ M : Pr \{ {p}_{i}^{*} ∉ [ {p}_{-} ( n , k , \frac{δ}{2 * m} ) , {p}_{+} ( n , k , \frac{δ}{2 * m} ) ] \} \leq \frac{δ}{m} , \qquad ( 9 )$$

therefore,

$$Pr \{ {∃}_{i} ∈ M : {p}_{i}^{*} ∉ [ {p}_{-} ( n , {k}_{i} , \frac{δ}{2 * m} ) , {p}_{+} ( n , {k}_{i} , \frac{δ}{2 * m} ) ] \} \leq δ \qquad ( 10 )$$

based on the Bonferroni correction/union bound. So

$${max}_{p ∈ {L}_{B}} p \cdot v \qquad ( 11 )$$

is an upper bound on p*·v, with probability at least 1−δ.

To find the maximizing p∈L_{B}, first assign each pᵢ to its lower bound. Define the difference between one and the sum of the pᵢ values as headroom and update it at each step. For each pᵢ value staring with pₘ and working back to pᵢ. When the headroom is greater than zero, add the headroom or the difference between the upper and lower bound for pᵢ, whichever is least. This allocates the distribution to the rightmost pᵢ values, to the extent allowed by the upper bounds for the rightmost values while also allocating at least the lower bounds for the leftmost elements. As v₁< . . . <vₘ, this process maximizes p·v.

Instead of applying binomial inversion bounds to each category individually, it is possible to compute binomial inversion bounds for probabilities of multiple categories together, then use those bounds to infer individual-category bounds, or use them directly as constraints on p. This can improve the resulting bound on p*·v. As the variance of a binomial distribution is np(1−p), so the standard deviation of each category's number of samples is \sqrt{np(1−p)}, where p is the category probability. The differences between frequencies and binomial inversion bounds scale approximately with the standard deviation of the number of samples in the category, divided by the total number of samples:

$$\frac{\sqrt{np ( 1 - p )}}{n} = \sqrt{\frac{p ( 1 - p )}{n}} \qquad ( 12 )$$

If c categories are combined with each having probability p, then the combined probability is cp. Thus, the difference between the resulting binomial inversion bound and the combined frequency scales is

$$\sqrt{\frac{cp ( 1 - cp )}{n}} \leq \sqrt{c} \sqrt{\frac{p ( 1 - p )}{n}} \qquad ( 13 )$$

This is about \sqrt{c} times the difference between frequency and bound for a single category. In contrast, if c categories are bounded separately and then the individual bounds are summed, then the difference between sum of frequencies and sum of bounds is c times the difference for a single category. Given that, improved or tighter bounds on combined categories can be obtained by summing frequencies first then bounding instead of bounding frequencies then summing.

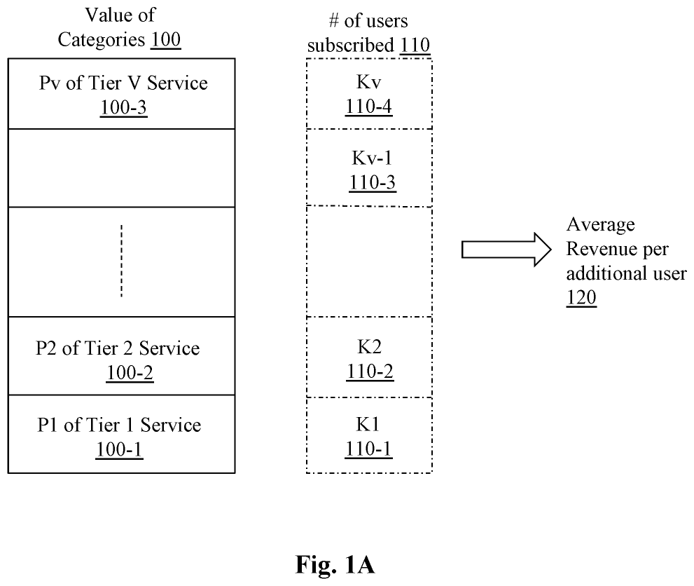

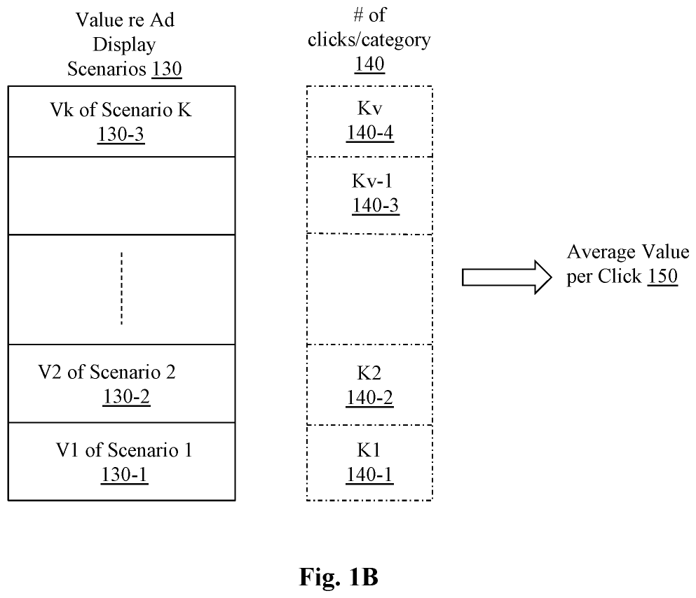

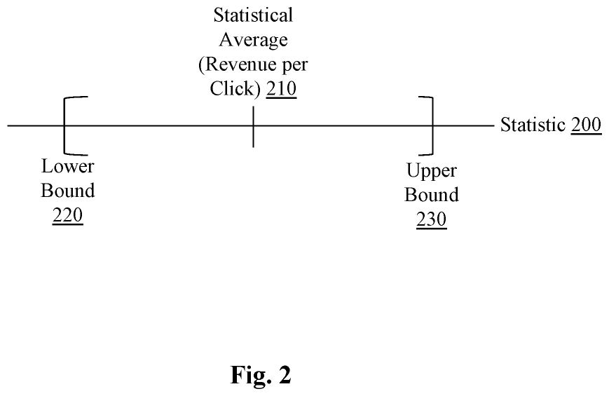

Accordingly, the present teaching discloses a method for obtaining improved bounds for means of discrete-valued distributions such as the ones illustrated in FIGS. 1A and 1B. Let

$${t}_{0} = 0 , \qquad ( 14 )$$

$${∀}_{i} ∈ M - \{ m \} : {t}_{i} = {p}_{-} ( n , {\sum }_{j = 1}^{i} {k}_{j} , \frac{δ}{m - 1} ) , \qquad ( 15 )$$

$${t}_{m} = 1. \qquad ( 16 )$$

Given that, each tᵢ is a lower bound on p₁*+ . . . +pᵢ*. The bounds hold simultaneously with probability at least 1−δ (as the bound tₘ=1 follows from p* being a probability vector.)

Let L_{N} be the set of probability vectors p that satisfy the lower-bound constraints:

∀ᵢ∈M:pᵢ+ . . . +pₜ≥tᵢ. (17)

As v₁< . . . <vₘ, to maximize p·v over p∈L_{N}, as little probability is placed in earlier pᵢ values, and as much in later ones, as possible.

First consider the situation with p₁. Since p₁≥t₁, t₁ is the least probability that we can assign to p₁. So, set pᵢ=t₁=t₁−t₀. For i>1, the lower bound p₁+ . . . +pᵢ₋₁≥tᵢ₋₁. As the previous lower bound, p₁+ . . . +pᵢ₋₁≥tᵢ₋₁, assign at least tᵢ₋₁ in total to pᵢ+ . . . +pᵢ₋₁. That leaves as the most of tᵢ−tⁱ⁻¹ that can be assigned to pᵢ while assigning the minimum possible (tᵢ) to the sum p₁+ . . . +pᵢ (assigning that minimum leaves as much probability as possible for pᵢ₊₁+ . . . +pₘ). Thus, to maximize p·v, assign each pᵢ=tᵢ−tᵢ₋₁. The resulting p is a probability vector as the sum is one because t₀=0 and tₘ=1. Each entry is nonnegative as t₀≤ . . . ≤tₘ because binomial inversion bounds increase monotonically in k. To obtain a lower bound, the same procedure is applied to reversed k and v. For simultaneous upper and lower bounds,

$$\frac{δ}{2}$$

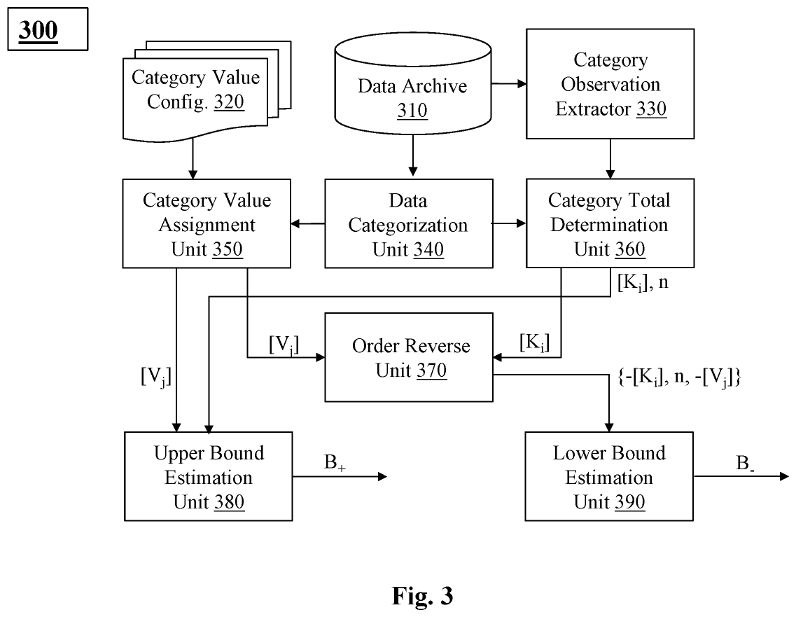

is used in place of δ for each bound, because the nested bounds nest in different directions (right and left in the original category ordering) in the two bounds, collecting different sets of categories. The technical implementation details are provided with reference to FIGS. 3-6B.

FIG. 3 depicts an exemplary high-level system diagram of a mechanism 300 for determining bounds of a mean of data having a discrete-valued distribution, in accordance with an exemplary embodiment of the present teaching. In this illustrated embodiment, the mechanism 300 comprises a data archive storage 310 providing data with discrete-valued distributions for determining bounds of means of such discrete-valued distributions. The data collected may record information related to different categories (e.g., different tiers of a service) and observations (e.g., the number of users selecting a specific tier of the service). The observations may form a discrete-valued distribution and such information may be collected in operation and archived so that it can be used to estimate the bounds of means of the discrete-valued distribution.

To carry out the operation of estimating the bounds of means of the data of discrete-valued distribution archived in the storage 310, the mechanism 300 further includes a category observation extractor 330 for extracting category relevant observations (e.g., clicks of an advertisement displayed in each category scenario), a data categorization unit 340 for categorizing the data collected (e.g., grouping clicks of advertisement occurred in each category scenario), a category value assignment unit 350 for assigning a value to each of the categories based on a configuration stored in a category value storage 320 (e.g., a value for each click on the advertisement on a specific scenario category), a category total determination unit 360 for computing the total number of observations across all categories (e.g., the total number of clicks on the advertisement in all scenarios), an order reverse unit 370 for reversing the categories and observations, an upper bound estimation unit 380 for computing the upper bound of the mean of the data being considered, and a lower bound estimation unit 390 for computing the lower bound of the mean.

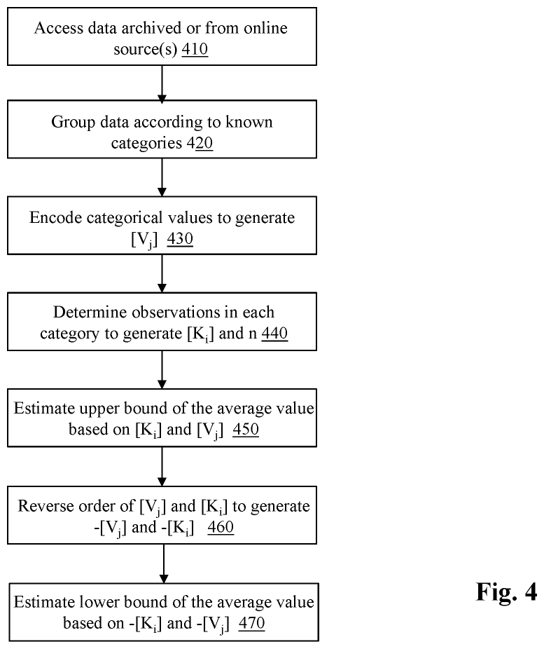

FIG. 4 is a flowchart of an exemplary process for the mechanism 300 for determining bounds of a mean based on data, in accordance with an exemplary embodiment of the present teaching. As discussed herein, to determine the bounds of a mean of data having a discrete-valued distribution, the data archived in 310 is accessed at 410. The accessed data are grouped according to known categories at 420 and each of the categories is encoded with a code or value configured in 320 to generate [Vⱼ] at 430. With respect to each of the categories, observations are extracted from the data to generate [Kᵢ] at 440 and a total n=Σᵢ₌₁^{m}Ki is computed. Based on [Kᵢ] and [Vⱼ] so determined, the upper bound estimation unit 380 is invoked to compute, at 450, the upper bound p₊ to the mean of the data.

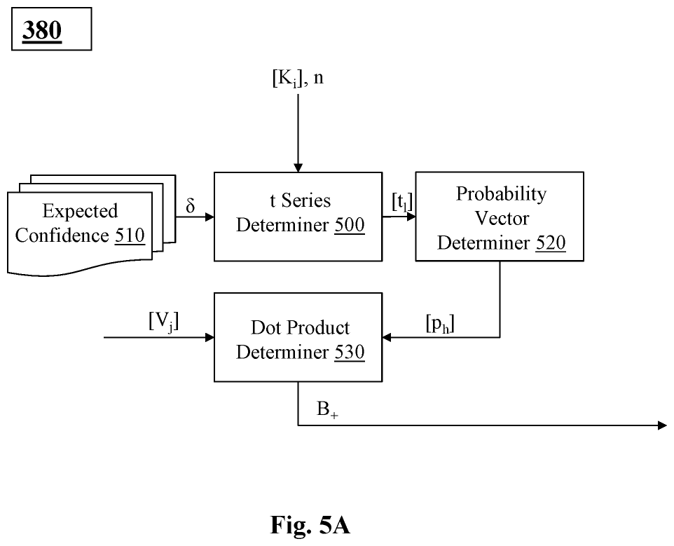

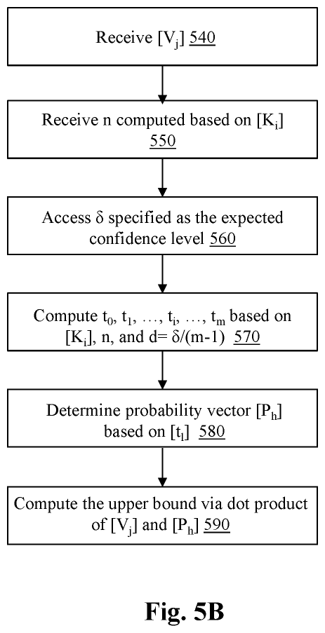

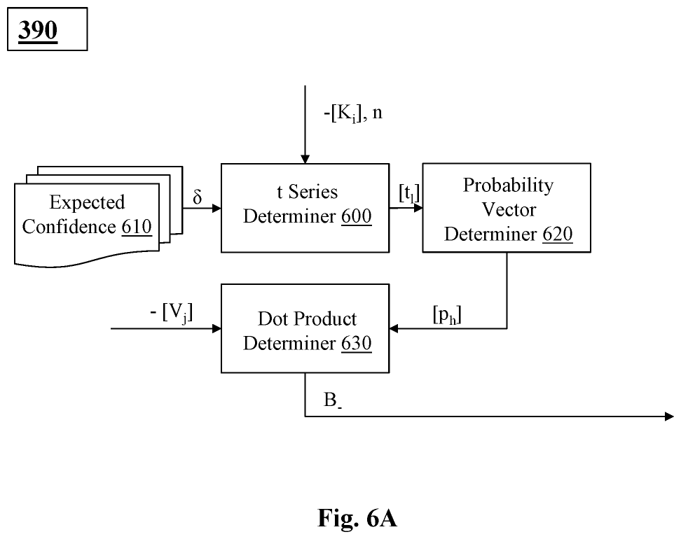

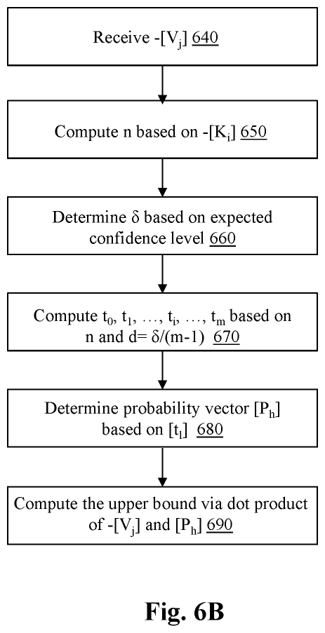

To compute the lower bound, the order reverse unit 370 is invoked to reverse, at 460, the order of both [Kᵢ] and [Vⱼ] to generate −[Kᵢ] and −[Vⱼ]. That is, V₁=Vₘ, V₂=V₍ₘ₋₁₎, . . . , Vₘ=V₁, and K₁=Kₘ, K₂=K₍ₘ₋₁₎, . . . , Kₘ=K₁. −[Kᵢ] and −[Vⱼ] are then used to compute the lower bound p₋ at 470. The details of computing the upper and lower bounds of the means are provided with reference to FIGS. 5A-6B.

FIG. 5A depicts an exemplary high-level system diagram of the upper bound estimation unit 380, in accordance with an exemplary embodiment of the present teaching. As described herein, in computing an upper bound, the formulations in (14), (15), and (16) are used to compute [t₁], 1<=1<=m, in accordance with a specified confidence level on the estimate bound. Then, based on [t₁], pᵢ=tᵢ−t₍ᵢ₋₁₎, 1<=i<=m, are computed to generate pᵢ, 1<=i<=m. Based on [Vⱼ] and [pₕ], dot product p·v is computed to derive the upper bound of the mean of the distribution. As shown in FIG. 5A, the upper bound estimation unit 380 comprises a t series determiner 500, a probability vector determiner 520, and a dot product determiner 530. The t series determine 500 is for computing [t₁] based on a specified confidence level δ, the input categorical observations [Kᵢ], and the total of observations n summarized over all categories. The probability vector determiner 520 is for computing [pₕ] based on the t series [t₁] based on pᵢ=tᵢ−t₍ᵢ₋₁₎. Then the dot product determiner 530 is for computing the upper bound B₊ of the mean by taking dot product p·v based on the input [Vⱼ] and [pₕ].

FIG. 5B is a flowchart of an exemplary process of the upper bound estimation unit 380, in accordance with an exemplary embodiment of the present teaching. At 540, the discrete coding or value of the categories [Vⱼ] are received and the total of observations n is received at 550. The specified confidence level δ for the upper bound is then accessed at 560. These input data are used by the t series determiner 500 to compute, at 570, the t series based on formulae (14)-(16). The computed t series is then used to compute, at 580, the probability vector [pₕ]. Based on [Vⱼ] and [pₕ], the dot product determiner 530 then computes, at 590, the dot product as the upper bound estimate.

FIG. 6A depicts an exemplary high-level system diagram of the lower bound estimation unit 390 and FIG. 6B is a corresponding exemplary flowchart of the lower bound estimation unit 390, in accordance with an exemplary embodiment of the present teaching. As discussed herein, the process of computing a lower bound of a mean of a discrete-valued distribution is the same as that for an upper bound except that the input to the lower bound estimation unit 390 is the reversed [Vⱼ] and [Kᵢ], i.e., −[Vⱼ] and −[Kᵢ]. As such, the lower bound estimation unit 390 is constructed similarly as the upper bound estimation unit 380 but takes −[Vⱼ] and −[Kᵢ] as its input, as shown in FIG. 6A (600 and 630 takes reversed input data). Accordingly, the operational flow, as shown in FIG. 6B, has the same procedural steps except that the input data being processed at steps 640, 650, and 690.

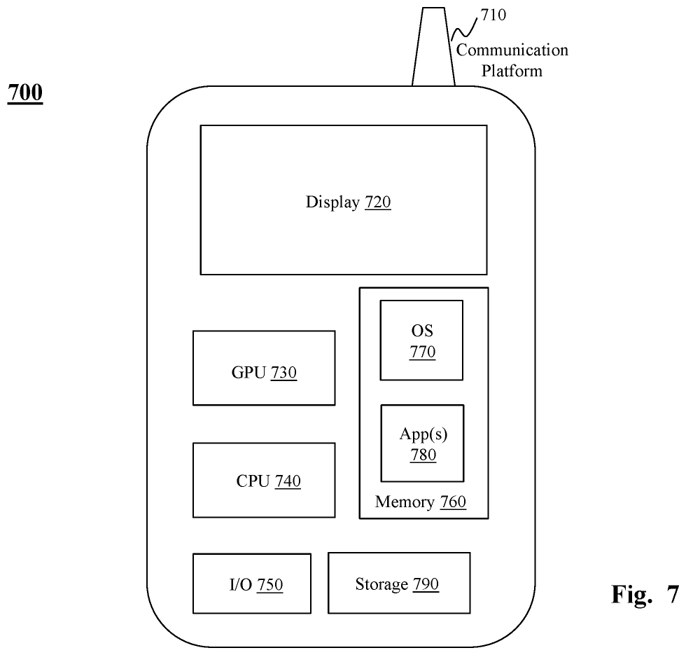

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handled gaming console, a global positioning system (GPS) receiver, and a wearable computing device, or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a user interface or any other suitable mobile apps for information analytics and management according to the present teaching on, at least partially, the mobile device 700. User interactions, if any, may be achieved via the I/O devices 750 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

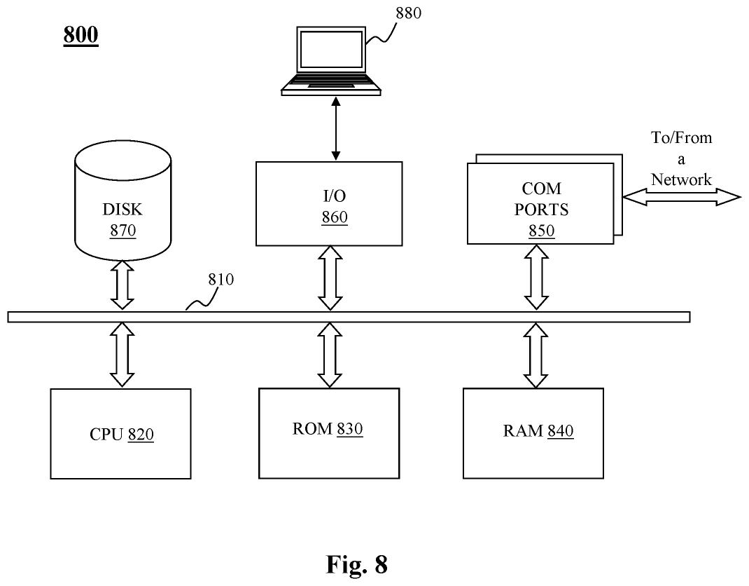

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of dialogue management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution−e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one processor, a memory, and a communication platform for characterizing data, comprising:
receiving data including categorical classes and a number of observations with respect to each of the categorical classes, wherein each of the categorical classes is associated with a category value and the categorical classes are arranged in a first order based on their corresponding category values;
determining a total of observations based on the numbers of observations with respect to the respective categorical classes; and
estimating a bound of an average value of the data based on the categorical classes, the total of observations, and the numbers of observations with respect to the categorical classes in accordance with a dot product of a probability vector and a categorical class vector comprising the category values of the categorical classes.

2. The method of claim 1, wherein observations associated with the categorical classes correspond to a discrete-valued distribution.

3. The method of claim 1, wherein the category value associated with each of the categorical classes represents an assessment of a return value associated with the categorical class.

4. The method of claim 1, wherein
the bound of the average value of the data is specified by a lower bound and an upper bound;
the lower and upper bounds are estimated based on the data with respect to an expected confidence level.

5. The method of claim 4, wherein the upper bound of the average value of the data is estimated by:
generating the categorical class vector V=[v₁, v₂, . . . , vₘ] and the corresponding number of observations to generate a sample number vector K=[k₁, k₂, . . . , kₘ], wherein m represents a number of categorical classes;
calculating
a plurality oft measures, t₀, t₁, . . . tₘ, wherein t₀=0, tₘ=1, tᵢ=lower bound of (n, k₁+k₂+ . . . +, kᵢ, d) for 1<=i<m, where d is a function of the expected confidence level, and
the probability vector P=[p₁, p₂, . . . , pₘ] with pᵢ=tᵢ−tᵢ₋₁; and
computing the upper bound of the average value as the dot product of vectors P and V.

6. The method of claim 4, further comprising
reversing the first order of the categorical classes to generate a reversed categorical class vector −V=[vₘ, vₘ₋₁, . . . , v₁] in a second order;
reversing the order of the number of observations corresponding to the reversed categorical classes to generate a reversed sample number vector −K=[kₘ, kₘ₋₁, . . . , k₁].

7. The method of claim 6, wherein the lower bound of the average value is computed by
calculating
a plurality of reversed t measures, t₀, t₁, . . . tₘ, wherein t₀=0, tₘ=1, tᵢ=lower bound of (n, (kₘ)+(kₘ₋₁)+(−kᵢ), d) for 1<=i<m, and
a reversed probability vector −P with m probability measures, including pᵢ=tᵢ−tᵢ₋₁; and
computing the lower bound of the average value as the dot product of the reversed categorical class vector −V and the reversed probability vector −P.

8. Machine readable and non-transitory medium having information recorded thereon for characterizing data, wherein the information, when read by the machine, causes the machine to perform the following steps:
receiving data including categorical classes and a number of observations with respect to each of the categorical classes, wherein each of the categorical classes is associated with a category value and the categorical classes are arranged in a first order based on their corresponding category values;
determining a total of observations based on the numbers of observations with respect to the respective categorical classes; and
estimating a bound of an average value of the data based on the categorical classes, the total of observations, and the numbers of observations with respect to the categorical classes in accordance with a dot product of a probability vector and a categorical class vector comprising the category values of the categorical classes.

9. The medium of claim 8, wherein observations associated with the categorical classes correspond to a discrete-valued distribution.

10. The medium of claim 8, wherein the category value associated with each of the categorical classes represents an assessment of a return value associated with the categorical class.

11. The medium of claim 8, wherein
the bound of the average value of the data is specified by a lower bound and an upper bound;
the lower and upper bounds are estimated based on the data with respect to an expected confidence level.

12. The medium of claim 11, wherein the upper bound of the average value of the data is estimated by:
generating the categorical class vector V=[v₁, v₂, . . . , vₘ] and the corresponding number of observations to generate a sample number vector K=[k₁, k₂, . . . , kₘ], wherein m represents a number of categorical classes;
calculating
a plurality of t measures, t₀, t₁, . . . tₘ, wherein t₀=0, tₘ=1, tᵢ=lower bound of (n, k₁+k₂+ . . . , kᵢ, d) for 1<=i<m, where d is a function of the expected confidence level, and
the probability vector P=[p₁, p₂, . . . , pₘ] with pᵢ=tᵢ−tᵢ₋₁; and
computing the upper bound of the average value as the dot product of vectors P and V.

13. The medium of claim 11, wherein the information, when read by the machine, further causes the machine to perform the following steps:
reversing the first order of the categorical classes to generate a reversed categorical class vector −V=[vₘ, vₘ₋₁, . . . , v₁] in a second order;
reversing the order of the number of observations corresponding to the reversed categorical classes to generate a reversed sample number vector −K=[kₘ, kₘ₋₁, . . . , k₁].

14. The medium of claim 13, wherein the lower bound of the average value is computed by
calculating
a plurality of reversed t measures, t₀, t₁, . . . tₘ, wherein t₀=0, tₘ=1, tᵢ=lower bound of (n, (kₘ)+(kₘ₋₁)+ . . . , (−kᵢ), d) for 1<=i<m, and
a reversed probability vector −P with m probability measures, including pᵢ=tᵢ−tᵢ₋₁; and
computing the lower bound of the average value as the dot product of the reversed categorical class vector −V and the reversed probability vector −P.

15. A system for characterizing data, comprising:
a data categorization unit configured for receiving data including categorical classes, wherein each of the categorical classes is associated with a category value and the categorical classes are arranged in a first order based on their corresponding category values;
a category observation extractor configured for identifying a number of observations from the data with respect to each of the categorical classes;
a category total determination unit configured for determining a total of observations based on the numbers of observations with respect to the respective categorical classes; and
a bound estimation mechanism configured for estimating a bound of an average value of the data based on the categorical classes, the total of observations, and the numbers of observations with respect to the categorical classes in accordance with a dot product of a probability vector and a categorical class vector comprising the category values of the categorical classes.

16. The system of claim 15, wherein observations associated with the categorical classes correspond to a discrete-valued distribution.

17. The system of claim 15, wherein the category value associated with each of the categorical classes represents an assessment of a return value associated with the categorical class.

18. The system of claim 15, wherein
the bound of the average value of the data is specified by a lower bound and an upper bound;
the lower and upper bounds are estimated based on the data with respect to an expected confidence level.

19. The system of claim 18, wherein the bound estimation mechanism includes an upper bound estimation unit for determining the upper bound of the average value of the data by:
generating the categorical class vector V=[v₁, v₂, . . . , vₘ] and the corresponding number of observations to generate a sample number vector K=[k₁, k₂, . . . , kₘ], wherein m represents a number of categorical classes;
calculating
a plurality oft measures, t₀, t₁, . . . tₘ, wherein t₀=0, tₘ=1, tᵢ=lower bound of (n, k₁+k₂+ . . . , kᵢ, +d) for 1<=i<m, where d is a function of the expected confidence level, and
the probability vector P=[p₁, p₂, . . . , pₘ] with pᵢ=tᵢ−tᵢ₋₁; and
computing the upper bound of the average value as the dot product of vectors P and V.

20. The system of claim 18, wherein the bound estimation mechanism further comprises a lower bound estimation unit configured for determining the lower bound of the average value of the data by:
reversing
the first order of the categorical classes to generate a reversed categorical class vector −V=[vₘ, vₘ₋₁, . . . , v₁] in a second order, and
the order of the number of observations corresponding to the reversed categorical classes to generate a reversed sample number vector −K=[kₘ, kₘ₋₁, . . . , k₁];
calculating
a plurality of reversed t measures, t₀, t₁, . . . tₘ, wherein t₀=0, tₘ=1, tᵢ=lower bound of (n, (kₘ)+(kₘ₋₁)+ . . . , (−kᵢ), d) for 1<=i<m, and
a reversed probability vector −P with m probability measures, including pᵢ=tᵢ−tᵢ₋₁; and
computing the lower bound of the average value as the dot product of the reversed categorical class vector −V and the reversed probability vector −P.
